(19) United States
(12) Patent Application Publication
(10) Pub. No.: US 2003/0004698 A1
(43) Pub. Date: Jan. 2, 2003

(54) Agent state drive simulation and method for detecting simulated drive fights

(76) Inventors: Daniel D. Osborn, Fort Collins, CO (US); Thomas J. Kennedy, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/896,612

(22) Filed: Jun. 29, 2001

(51) Int. Cl. G06F 17/50

(52) U.S. Cl. 703/14

(57) ABSTRACT

A method for detecting bus fights in a simulated bus system comprising simulating a first logic sequence and a second logic sequence respectively representing an output sequence of a first simulated device and a second simulated drive to a simulated bus, and determining a bus fight condition exists when a high logic state of the first logic sequence and the second logic sequence is detected on an adjacent clock cycle is provided. A computer executable program operable to cause a computer to simulate a respective sequence of logic states of a first device and a second device, determine the first device has gained access to the bus during a first clock cycle, analyze the logic state of the second device, and determine a bus fight condition exists when the second device has gained access to the bus during a clock cycle adjacent to the first clock cycle is provided.

### TECHNICAL FIELD OF THE INVENTION

This invention relates to bus arbitration and, more particularly, to a system and method for detecting drive fights during bus arbitration simulation.

### BACKGROUND OF THE INVENTION

Computer systems commonly have a plurality of components, such as processors, memory, and input/output devices, and a shared bus for transferring information among two or more of the components. The components commonly are coupled to the bus in the form of device modules, each of which may contain one or more processors, memory, and/or input/output devices. Information is transmitted on the bus among the devices during bus “cycles,”0 each bus cycle being a period of time during which a device has control of the bus and is permitted to transfer, or drive, a limited quantity of information on the bus. Modules communicate by sending each other data on the bus that take one or more cycles to complete, such as conventional “read”0 and “write”0 operations.

Typically, only one device can send, or drive, information on a shared bus in a given cycle. Thus, any shared bus system must have a bus arbitration scheme for determining which device is entitled to drive information on the bus in a particular cycle. Many conventional bus arbitration schemes are available. In most arbitration schemes, each device in a shared bus system generates a signal when it wants to drive the bus, and an arbitration algorithm, or bus arbitrator, implemented on one or more processors determines which device is entitled to drive the bus during a given cycle.

Conventional arbitration schemes are generally designed to allow each device seeking to use the bus an opportunity to do so. Thus, each device is able to make forward progress on the transactions it needs to issue. For example, in a conventional round-robin arbitration scheme, the modules are effectively queued for arbitration priority purposes. The device at the head of the queue gains control of the bus during the next available bus cycle and is then placed at the end of the queue. Many conventional arbitration schemes are available that are more complex than a round-robin scheme.

However, drive fights, also referred to herein as bus fights, often result between devices seeking to simultaneously access the bus. Bus arbitration schemes are designed to prevent such drive fights. Due to oversights in bus arbitration protocol design as well as differences in device performances relative to idealized device performances used during bus arbitration design, drive fights still often occur. The potential for drive fights is ideally determined during design of the bus system, that is during conceptualization and simulation of the bus system. Typically, a conceptualized bus system is analyzed by simulating various bus access configurations respectively including various device access configurations and various device access characteristics in order to simulate real-world conditions the bus may be subjected to. Signal collisions, in which two devices attempt to drive signals onto the bus concurrently in a situation referred to as a drive fight, in simulated bus systems may be detected with common bus simulation systems. A conceptualized bus system may then be re-designed to avoid a physical implementation of the bus having characteristics that may result in the drive fight of the simulated bus system.

Hardware description languages, such as Verilog®, are commonly used in the design of circuits and bus arbitration systems may be designed and simulated thereby. Electronic circuit design and gate level simulators may provide simulation of various bus characteristics and simulated microprocessor and/or peripheral devices access to the bus. For example, bus design and arbitration circuit simulators may accurately simulate a conceptualized bus clock rate, propagation characteristics of address, data and control signals driven on the bus and drive characteristics, such as signal drive delays, of devices that may access the bus. The simulation is generally implemented by one or more computer executable programs that comprise mathematical models that predict and simulate the behavior of the simulated bus system under one or more scenarios. Various arbitration schemes may accordingly be simulated by a bus simulation system.

However, bus simulation systems do not generally detect bus simulations drive states having two devices attempt to drive signals onto the bus on adjacent clock cycles—a situation generally indicative of a drive fight. Accordingly, while bus simulation systems are helpful for eliminating bus design configurations that may lead to drive fights, implementation of bus systems nevertheless often result in bus systems that may result in drive fights thereon due to the failure to identify potential drive fight conditions characterized by drive access by multiple devices on adjacent clock signals.

### SUMMARY OF THE INVENTION

In accordance with an embodiment of the present invention, a method for detecting bus fights in a simulated bus system comprising simulating a first logic sequence representing an output sequence of a first simulated device to a simulated bus, simulating a second logic sequence representing an output sequence of a second simulated device to the simulated bus and determining a bus fight condition exists when a high logic state of the first logic sequence is detected on an adjacent clock cycle to a high logic state of the second logic sequence is provided.

In accordance with another embodiment of the invention, a computer executable program operable to cause a computer to simulate a respective sequence of logic states of a first device and a second device, read the sequence of logic states by a drive state monitor module, determine the first device has gained access to the bus during a first clock cycle, analyze, for the first clock cycle and a clock cycle prior to and subsequent to the first clock cycle, the logic state of the second device, and determine a bus fight condition exists if one of the analyzed logic states of the second device indicates the second device has gained access to the bus is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a schematic of a shared bus and devices that may perform data writes and reads on the bus 10 that may be simulated by a simulated bus system according to an embodiment of the present invention.;

FIG. 2 illustrate a simulated bus system according to an embodiment of the invention that may simulate the shared bus and devices described with reference to FIG. 1;

FIG. 3A illustrates device module output states that may be maintained in a drive state monitor module 80 of a simulated bus system according to an embodiment of the invention; and

FIGS. 3B-3D show output logic states maintained by a drive state simulation module according to an embodiment of the invention.

### DETAILED DESCRIPTION OF THE DRAWINGS

The preferred embodiment of the present invention and its advantages are best understood by referring to FIGS. 1 through 3 of the drawings, like numerals being used for like and corresponding parts of the various drawings.

The present invention provides a program and method for monitoring the drive state and/or the output enable state of each device that may access a bus in a simulated bus system. Simulated address and data signals driven by the devices sharing the bus are continuously monitored by a drive state monitoring module that maintains the address and data output logic states from all devices sharing the bus preferably for at least three clock cycles, but those skilled in the art will recognize four or more clock cycles may be maintained by the drive state monitoring module. When a device begins driving a signal on the bus in the simulated bus system, an analysis of the drive states of the remaining device(s) that may access the bus for the previous clock cycle and the present clock cycle is then made by the drive state monitoring module. The drive state for the remaining device(s) during the following clock cycle is also evaluated so that an attempt by a device to access the bus a clock cycle after access, in addition to an attempt to access the bus on a clock cycle prior to access by the first device, by the first device may be detected thus providing an indication of a bus fight condition.

In FIG. 1, there is illustrated a schematic of a shared bus 10 and devices 20 and 21 that may perform data writes and reads on bus 10 and that may be simulated by a bus arbitration simulation system according to an embodiment of the present invention. Device 20 is coupled to bus 10 via an address line 30 for driving an address signal onto bus 10. A data line 31 couples device 20 with bus 10 and allows data transfers thereacross to be driven onto bus 10. Likewise, device 21 includes an address line 40 for driving an address signal onto bus 10 and a data line 41 couples device 21 with bus 10 and allows data transfers to be driven thereacross onto bus 10. While address lines 30 and 40 are illustrated as single line mediums for sequential transfer of address bits, address lines 30 and 40 may each include a plurality of lines for driving address bits onto bus 10 in parallel. Similarly, data lines 31 and 41 may include a plurality of data lines for performing parallel data writes on bus 10. Accordingly, bus 10 includes one or more data lines 10A and one or more address lines 10B. A bus arbitrator 60 may be coupled to a respective output ENABLE 25 and 26 of devices 20 and 21 for granting one of devices 20 and 21 write access to bus 10. Bus arbitrator 60 may employ any one of numerous conventional bus arbitration schemes. In general, bus arbitrator 60 implements a bus arbitration scheme to determine which device gains access and control of bus 10 during any given clock cycle. Other devices, such as a memory module 70 and a processor 71, may be coupled to bus 10 and bus arbitrator 60 and may gain control of bus 10 via bus arbitrator 60. Furthermore, one of devices 20 and 21, memory module 70 and processor 71 may receive control of bus 10 under default conditions. In the forthcoming description, only bus arbitration, and simulation thereof, between device 20 and 21 will be described to simplify the discussion of the invention.

Devices 20 and 21, also collectively referred to herein as ‘agents’, that need to utilize bus 10 arbitrate for control of bus 10 during any given clock cycle. Various bus arbitration protocols have been developed that attempt to eliminate the occurrence of simultaneous access of bus 10 by device 20 and 21. However, often due to errors in the protocol or variations in operation of devices 20 and 21, a bus fight may occur and result in failure of bus arbitration or erroneous read and/or writes thereto. In general, a bus fight condition may exist when two devices attempt to drive a signal to a shared bus on a common clock cycle or during adjacent clock cycles. However, state of the art bus design tools, such as computer simulated circuit systems, only detect occurrences of simultaneous bus access by bus agents when analyzing a bus design for potential deficiencies thereof. The present invention provides a system and method of simulating and monitoring the drive state of each agent that may arbitrate for control of a bus and detect a bus fight via agent drives to the bus on adjacent clock cycles.

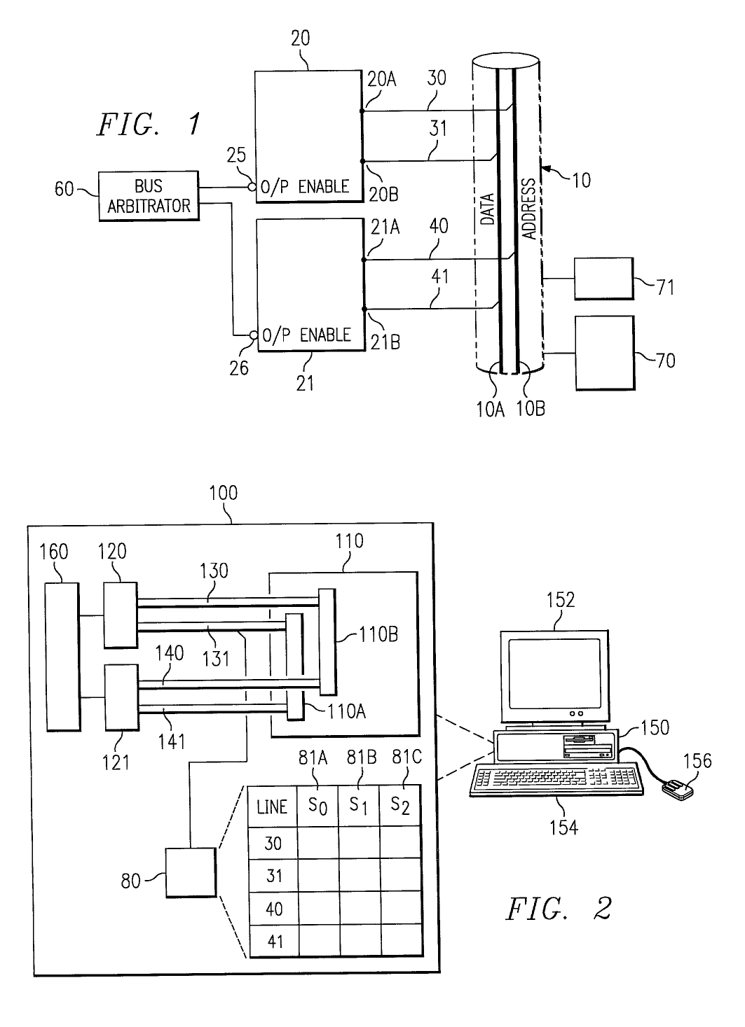

In FIG. 2, there is illustrated a simulated bus system 100 according to an embodiment of the invention that may simulate shared bus 10 and devices 20 and 21 described with reference to FIG. 1. Simulated bus system 100 may be implemented as computer executable code that is storable on a storage medium, such as a magnetic hard disk or floppy disk, an optical medium or other digital storage device, and executable by a central processing unit of a computer 150. Computer 150 may have various peripheral devices including a monitor 152, a keyboard 154 and a mouse 156 for providing output to a user thereof and for receiving input from a user thereof. Simulated bus system 100 comprises numerous modules including a shared bus module 110 and one or more agent modules 120 and 121 that simulate access requests and signal drives to bus module 1 10 via simulated bus arbitrator module 160 and, in general, simulate various component behaviors and logic states of elements of a bus system, such as shared bus 10 illustrated in FIG. 1. Simulated bus system 100 further comprises a drive state monitor module 80 that operates to store and monitor the simulated drive states of agent modules 120 and 121 for the occurrence of a simulated bus fight according to the teachings of the invention. A clock module 65 may be simulated by bus system 100 as well. Drive state monitor module 80 maintains a plurality of output states 81A-81C that respectively indicate drive states of device module 120 on address line module 130 and data line module 131 and device module 121 drive states on address line module 140 and data line module 141 simulated by system 100. Output states 81A-81C may be maintained in a first-in first-out (FIFO) queuing manner and are indicative of simulated output sequences made from device modules 120 and 121.

Each module of simulated bus system 100 may include various rules, parameters and/or mathematical models that mathematically simulate the behavior of a respective device. For example, device module 120 may simulate a magnetic hard disk and may include a mathematical model that defines, or approximates, the electronic behavior of a magnetic hard disk. For example, module 120 may simulate read and write operations performable by a typical hard disk and may include simulated switching delays and propagation characteristics known in common hard disks. Line modules 130, 131, 140 and 141 may simulate characteristics of output signals provided by device modules 120 and 121 on a conductive medium. Bus module 110 may comprise a data module 110A and an address module 110B that respectively simulate one or more data lines and one or more address lines and may include behavior parameters such as a simulated clock rate that governs the behavior thereof. Each of the modules of the simulated bus system may interact with other modules and may be operable to provide input, or function arguments, to other modules. Inter-module interaction may be performed by subroutine and/or function calls, program callbacks, and/or other software processing routines understood by those skilled in the art.

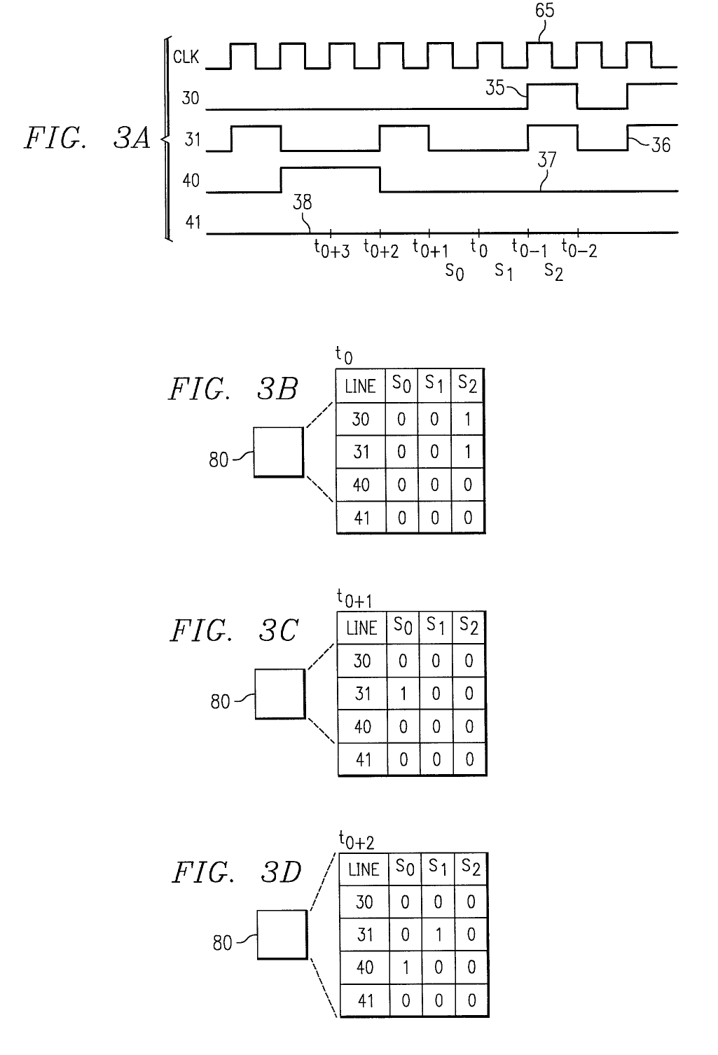

In FIG. 3A, there is illustrated exemplary device modules 120 and 121 output states that may be maintained in drive state monitor module 80, for example by function calls to and/or from drive state monitor module 80 and device modules 120 and 121, as well as a simulated clock cycle. Reference to signal drives by device modules 120 and 121 is understood to indicate a simulated signal drive. A simulated sequence 35 of address output signals and a simulated sequence 36 of data output signals of device module 120 are illustrated. Likewise, a simulated sequence 37 of address output signals and a simulated sequence 38 of data output signals for device module 121 are illustrated. A reference cycle is denoted as t₀. Previous clock cycles are denoted as increments of t₀, for example t₀₊₁, and t₀₋₂. Subsequent clock cycles are denoted as decrements of t₀, for example t₀₋₁, and t₀₋₂ Clock cycles separated by only one clock cycle, for example t₀ and t₀₊₁, are referred to as adjacent clock cycles. Preferably, drive state monitor module 80 is operable to monitor three or more sequential cycles of device modules 120 and 121. State drive monitor module 80 preferably provides a FIFO queue for the simulated address and data output logic states of device modules 120 and 121. Stored data and address logic state information is referred to as S_{X} such that S₀ represents the logic state corresponding to a current clock cycle. Accordingly, a logic state S₁, represent a logic state one cycle previous to a logic state S₀.

State of the art simulated bus systems are generally operable to detect signal collisions between two or more device modules. A signal collision occurs when two or more devices attempt to drive a signal (data and/or address) to the bus. Detection of a signal collision during simulation indicates a flaw in the bus system design and/or performance limits thereof. Generally, bus systems require an idle clock cycle between any two bus access attempts by more than one device. Thus, during simulation the occurrence of signal drives by different devices on adjacent clock cycles is indicative of a drive fight. The present invention provides a method of detecting such a condition so that bus systems may be better designed and bus fights therein avoided.

Drive state monitor module 80 is operable to perform state comparison and analysis of output states of device modules 120 and 121. Upon detection of a signal driven to bus module 110 by a device module, for example device module 120, an analysis is made by logic state monitor module 80 of the drive state(s) for the same clock cycle of other device modules. Accordingly, logic state monitor module 80 is operable to compare logic states S₀-S₂ of device modules 120 and 121. Preferably, logic state monitor module 80 is operable to analyze different output states, for example address output and data output logic states, of device modules 120 and 121. Additionally, it is preferable that output logic states of device module 121 may be analyzed for a previous clock cycle when it is detected that device module 120 drives a signal onto bus module 110. Furthermore, it is preferable that output logic states of device module 121 may be analyzed for a subsequent clock cycle when it is detected that device module 120 drives a signal onto bus module 110.

With reference now to FIG. 3B, there is illustrated output logic state data of device modules 120 and 121 (corresponding to reference tₒ) that is analyzed by drive state monitor module 80. Drive state monitor module 80 preferably may store logic state information of three or more cycles (S₀, S₁, and S₂). Output logic state information is preferably written into drive state monitor module 80 each simulated clock cycle. Logic states read during a cycle of simulated output sequences 35-38 of device modules 120 and 121 are preferably written into drive state monitor module 80 each clock cycle in a first-in first-out manner. For example, FIG. 3B shows output logic state S₀ that indicates the logic state simulated on output line modules 130-131 and 140-141 at t₀. State drive monitor module 80 may detect bus access by device modules 120 and 121. In an embodiment, an evaluation for bus fight conditions is not made by state drive monitor module 80 until one of device modules 120 and 121 is detected driving a signal onto bus module 110. At t₀, neither device module 120 or 121 is driving a signal as indicated by all zero logic states S₀ of output line modules 130-131 and 140-141.

With reference now to FIG. 3C, there is shown output logic states maintained by state drive monitor module 80 at a subsequent clock cycle, that is one clock cycle after the output states summarized in FIG. 3B. Output states now represented by S₀ correspond to logic states of output sequences 35-38 at t₀₊₁. Accordingly, output states S₂ maintained in state drive monitor module 80 at t₀ have all been shifted out of state drive monitor module 80 and output states S₀ and S₁ (at t₀) have been respectively shifted to output states S₁ and S₂ (at t₀₊₁). As indicated by output sequences 35 at t₀₊₁, and logic state So for line 30, the address output of device module 120 is asserted at t₀₊₁. A check for a drive fight is then made by state drive monitor module 80 by evaluating whether device module 121 is attempting to drive a signal to bus module 110 during the current clock cycle or attempted to drive a signal to bus module 110 during the previous clock cycle. Accordingly, state drive monitor module 80 then evaluates logic states S₀ and S₁ for device module 121, that is the logic states of line modules 140 and 141 at t₀₊₁ and t₀. As illustrated by output sequences 37 and 38 and summarized in FIG. 3C, neither address or data output logic states S₀ and S₁ for device module 121 is asserted on the current clock cycle (t₀₊₁) or during the previous clock cycle (t₀). Accordingly, assertion of an address signal by device module 120 is determined to be valid by drive state monitor module 80.

With reference now to FIG. 3D, there is shown output states maintained by state drive monitor module 80 at a subsequent clock cycle (t₀₊₂), that is one clock cycle after the output states summarized in FIG. 3C. Output states now represented by S₀ correspond to the logic states of output sequences 35-38 at t₀₊₂. Accordingly, logic states S₂ in state drive monitor module 80 at t₀₊₁ have all been shifted out (at t₀₊₂) of state drive monitor module 80 and output states S₀ and S₁ at t₀₊₁ have been respectively shifted to output states S₁ and S₂ at t₀₊₂. Because a signal was detected to be driven to bus module 110 by device module 120 in the previous clock cycle, a check is again made of output states S₀ of device module 121, thereby determining if an attempted signal drive to bus module 110 is made by device module 121 one clock cycle after the detected signal drive by device module 120. As illustrated by output state sequence 37 at t₀₊₂ in FIG. 3A and by logic state S₀ for line 40 in FIG. 3D, a signal drive by device module 121 on line module 140 is detected by drive state monitor module 80 and thus indicates a bus fight condition existing between device modules 120 and 121 as indicated by a respective signal drive on adjacent clock cycles by device modules 120 and 121. Simulated bus system 100 may then provide notification to a user of computer 150 of the existence of a bus fight condition in the simulated bus circuit.

In another embodiment, drive state monitor module 80 may maintain and monitor an ENABLE module of device module 120 and/or 121 that simulates ENABLE signals provided thereto by a simulated bus arbitration module 160. Simultaneous ENABLE signals, or adjacent ENABLE signals, to device modules 120 and 121 may indicate a drive fight condition and appropriate notification may be provided to a user of computer 150 executing simulated bus system 100.

Detection of a bus fight condition indicated by signals driven on adjacent clock cycles in a simulated bus circuit can then be accounted for during bus system design so that such scenarios are eliminated when the bus system is manufactured. Detection of a bus fight condition may invoke a notification thereof by simulated bus system 100. For example, a visual indication of a bus fight may be provided to a designer via monitor 152 coupled to computer 150 executing the simulated bus system 100.

What is claimed is:

1. A method for detecting bus fights in a simulated bus system, comprising:
simulating a first logic sequence representing an output sequence of a first simulated device to a simulated bus;
simulating a second logic sequence representing an output sequence of a second simulated device to the simulated bus;
determining a bus fight condition exists when a high logic state of the first logic sequence is detected on an adjacent clock cycle to a high logic state of the second logic sequence.

2. The method according to claim 2, wherein determining a bus fight condition exists further comprises determining a bus fight condition exists when a high logic state of the first logic sequence is detected on a clock cycle having a high logic state of the second logic sequence on the same clock cycle.

3. The method according to claim 1, wherein simulating a first logic sequence representing an output sequence of a first simulated device to a simulated bus further comprises simulating a logic sequence representing an output sequence of the first simulated device to the bus on an address line and simulating an output sequence of the first simulated device to the bus on a data line, and simulating a second logic sequence representing an output sequence of a second simulated device to the simulated bus further comprises simulating a logic sequence representing an output sequence of the second simulated device to the bus on an address line and simulating an output sequence of the second simulated device to the bus on a data line.

4. The method according to claim 3, wherein determining a bus fight condition exists when a high logic state of the first logic sequence is detected on an adjacent clock cycle to a high logic state of the second logic sequence further comprises determining a bus fight condition exists when a high logic state of the first simulated device on one of the address line and the data line is detected on an adjacent clock cycle of the high logic state of the second simulated device, the high logic state of the second simulated device on one of the address line and the data line.

5. The method according to claim 1, wherein simulating a first logic sequence further comprises simulating data and address signals driven by the first simulated device, the data and logic sequences including simulated drive delays.

6. The method according to claim 1, wherein simulating a first logic sequence representing an output sequence of a first simulated device to a simulated bus further comprises simulating a first logic sequence representing an output sequence of the first simulated device to the simulated bus having a simulated clock speed.

7. The method according to claim 1, further comprising simulating a bus arbitrator that enables high logic states within at least one of the first logic sequence and the second logic sequence.

8. The method according to claim 7, wherein simulating a bus arbitrator further comprises simulating an output enable transmission to the first simulated device and the second simulated device.

9. The method according to claim 1, further comprising simulating propagation delays between the first simulated device and the simulated bus and simulating propagation delays between the second simulated device and the bus.

10. The method according to claim 1, further comprising maintaining a record of a logic state of three consecutive cycles for each of the first logic sequence and the second logic sequence, the record maintained in a first-in first-out order.

11. A computer executable program, comprising:
a computer readable medium;
computer executable instructions residing on the computer readable medium and operable to cause the computer to execute the following steps:
simulating a respective sequence of logic states of a first device and a second device, each of the devices operable to drive signals to a bus;
reading the sequence of logic states by a drive state monitor module;
determining the first device has gained access to the bus during a first clock cycle;
analyzing, for the first clock cycle and a clock cycle prior to and subsequent to the first clock cycle, the logic state of the second device; and
determining a bus fight condition exists if one of the analyzed logic states of the second device indicates the second device has gained access to the bus.

12. The computer executable program according to claim 11, wherein reading a sequence of logic states further comprises reading a sequence of logic states of a simulated first line and a simulated second line that respectively model a connection between the first device and the second device to a bus arbitrator, the sequence of logic states representing a respective enable input of the first device and the second device.

13. The computer executable program according to claim 11, wherein reading a sequence of logic states further comprises reading a sequence of logic states of at least a first simulated line respectively modeling a connection between the first device and the bus and a second simulated line respectively modeling a connection between the second device and the bus, and determining the first device has gained access to the bus during a first clock cycle further comprises determining the first device simulates a signal drive to the bus during the first clock cycle.

14. The computer executable program according to claim 13, wherein reading a sequence of logic states further comprises reading a sequence of logic states of a simulated first plurality of lines respectively modeling a connection between the first device and the bus and reading a plurality of logic states of a simulated second plurality of lines respectively modeling a connection between the second device and the bus.

15. The computer executable program according to claim 13, wherein reading a sequence of logic states on a first simulated line further comprises reading a respective sequence of logic states of a simulated address line modeling a connection between the first device and the bus and a simulated data line modeling a connection between the first device and the bus, and reading a sequence of logic states on a second simulated line further comprises reading a respective sequence of logic states on a simulated address line modeling a connection between the second device and the bus and a simulated data line modeling a connection between the second device and the bus.
